(19) United States
(12) Patent Application Publication
(10) Pub. No.: US 2009/0281872 A1
(43) Pub. Date: Nov. 12, 2009

(54) TARGETING OF ADVERTISEMENTS TO A NETWORK CONTENT PROVIDER

(75) Inventor: Chris Theodore Kalaboukis, Los Gatos, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 12/119,483

(22) Filed: May 12, 2008

(51) Int. Cl. G06Q 30/00

(52) U.S. Cl. 705/10

(57) ABSTRACT

Embodiments are directed towards targeting postings of advertisements and personalized messages to a content provider based, in part, on content that the content provider posts over the network to a content site for access by other than the content provider. The content provider may register for and place a code snippet, or the like, onto a content site, such as a web page. The content provider may post any of a variety of content on the web page for access and/or viewing. The posted content and related activities of the content provider may be analyzed to identify content posting characteristics. When the content provider is detected to visit the content site, a targeted advertisement or other message, may be selected and displayed to the content provider based on the identified content posting characteristics.

### TECHNICAL FIELD

The present invention relates generally to communications over a network and, more particularly, but not exclusively to targeting advertisements and personalized messages to a content provider based, in part, on the content that they post over the network to a content site for access by other than the content provider.

### BACKGROUND

The explosive growth of the Internet in recent years has been accompanied by a tremendous increase in the amount of advertising on the Internet. Web pages, streaming video and other content transmitted across the Internet often have advertising and marketing content embedded or associated with it for reception by end users. Web pages often include one or more advertisements competing with each other for space and viewing time by the user. Which website or where generally to place an advertisement on the Internet is often a very important decision for a marketer or other business entity. An incorrect placement of an advertisement may often mean that the advertisement is ignored, or worse, viewed as intrusive or obnoxious. Properly placed advertisements often lead to higher profits, and brand recognition. Moreover, properly placed advertisements further may enable an advertiser to minimize wasted advertising expenditures. Thus, ensuring that an advertisement is properly targeted towards an audience that might want such information remains a major challenge. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention; and

FIG. 4 illustrates a logical flow diagram generally showing one embodiment of a process for managing advertisement selections targeted to at least a provider of content to a content site.

### DETAILED DESCRIPTION

The present invention now will be described more fully hereinafter with reference to the accompanying drawings, which form a part hereof and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards targeting postings of advertisements and personalized messages to a content provider based, in part, on content that the content provider posts over the network to a content site for access by other than merely the content provider. In one embodiment, the content provider may be a blogger and the content postings may be associated with blog postings. However, in another embodiment, the content provider may be an image poster, and the content postings may be of various images such as photographs, videos, or the like. However, the content posted may also include virtually any other material that the poster intends for access at a website by a viewer of that website, including, but not limited to audio files, articles, documents, or the like.

In one embodiment, a content provider may register for and place a code snippet or similar access mechanism onto a content site, such as a web page. The content provider may post any of a variety of content on the web page for access and/or viewing. The posted content and related activities of the content provider may be analyzed to identify content posting characteristics, including, but not limited to a frequency of the postings, a schedule of postings, content type of the postings, a subject matter of the postings, or the like. In one embodiment, where the content posted includes a photograph, or other image file, an analysis may be performed of an image file format associated with the posting to determine additional characteristics of the posted content. Such additional characteristics include but are not limited to a type of camera use to capture the image, camera settings, or the like.

When the content provider is detected to visit the content site, an advertisement may be selected and displayed to the content provider based on the identified content posting characteristics. In one embodiment, the displayed advertisement might include a name of the content provider, or other information uniquely identifying the content provider. The displayed advertisement may be selected to specifically target at least one characteristic associated with the content provider based on the posting characteristics. For example, the displayed advertisement might provide recommendations for a product that is detected to be used by the content provider and/or a competing product. For example, the analysis might identify that the content provider uses a particular software product to prepare and/or post the content. The advertisement might present offerings of products related to the particular software product, upgrades to the software product, and/or competing products to the particular software product.

Embodiments are further configured to present to the content provider an opportunity to provide recommendations useable in selecting advertisements that may subsequently be displayed to viewers of the content provider's web page that are other than the content provider. In this embodiment, the content provider might be identified as a sneezer, or an individual that tends to “forward” or otherwise distribute information more often than another category of individuals. The content provider might be presented with advertisements for products and/or services that the content provider might determine are of possible interest to viewers of the content provider's content site. For example, where the content provider's content site is associated with a blog about photography, the advertisements might be about classes in photography, products useable in photography, travel opportunities for photography, or the like. The content provider might then select or otherwise, provide recommendations about which of the presented advertisements might be appropriate to be displayed to viewers of the content site by other than the content provider. Thus, in one embodiment, targeted advertisements for display to other than the content provider may be selected based on input from the content provider. In this manner, advertisements are directed towards targeted viewers based on additional information about the viewer, and/or a category in which a user accessing the site may be classified within. Such determination of the category may be made, in part, on an action performed by the user/viewer accessing the web page, such as attempting to make a posting to the web page, or the like. However, in another embodiment, the determination may be made based on a browser cookie useable to identify the user/viewer, certificate, log-in actions, or the like.

### Illustrative Operating Environment

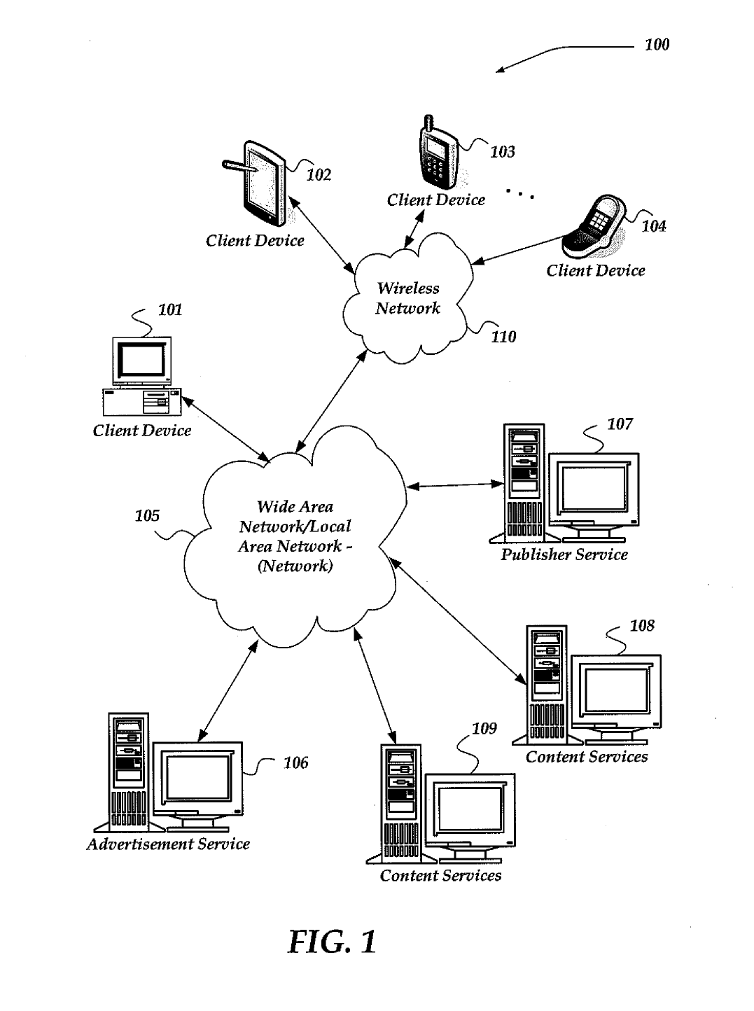

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, client devices 101-104; content services 108-109, advertisement service 106, and publisher service 107.

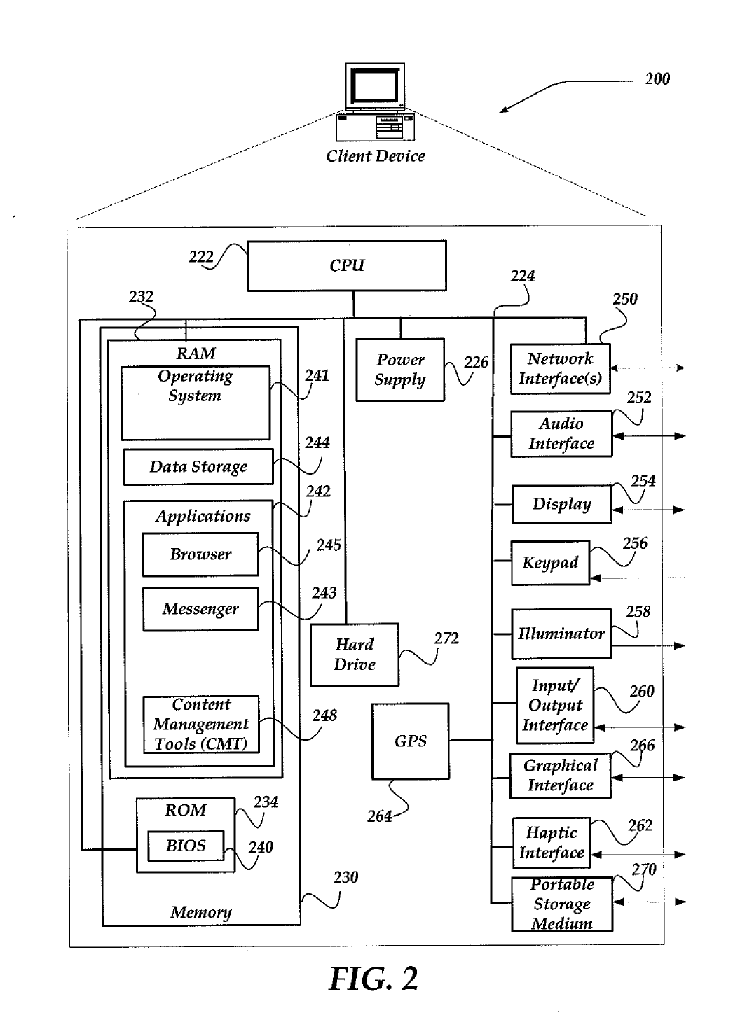

One embodiment of a client device usable as one of client devices 101-104 is described in more detail below in conjunction with FIG. 2. Briefly, however, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send webpages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-104 also may include at least one other client application that is configured to receive content from another computing device, including, without limit, content services 108-109. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device. Moreover, in one embodiment, client devices 101-104 might be configured to receive an Internet cookie, and provide the cookie to one or more network devices. Such cookies may also be useable to identify the client device.

Client devices 101-104 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to include a client application that enables the user to log into a user account that may be managed by another computing device. Such user account, for example, may be configured to enable the user to receive emails, send/receive IM messages, SMS messages, access selected webpages, download scripts, applications, or a variety of other content, or perform a variety of other actions over a network. However, managing of messages or otherwise accessing and/or downloading content, may also be performed without logging into the user account.

Thus, a user of client devices 101-104 may employ any of a variety of client applications to access content, read webpages, receive/send messages, or the like. In one embodiment, for example, the user may employ a browser or other client application to access a web page hosted by content services 108-109. In one embodiment, a user of one of client devices 101-104 may access one of content services 108-109, to view the content within a web page; while another user might be associated with providing content to be accessible by others at content services 108-109. The user providing the content may be referred to as a content provider, or the like. In one embodiment, the content might be of the type that is known as web log (or blog) content. As such, the content provider is often referred to as a blogger. The term content provider is intended to include any user that posts social networking content at a network device for access by another social network user.

Wireless network 110 is configured to couple client devices 102-104 to network 105. Wireless network 110 may include any of a variety of wireless sub-networks that may further overlay stand-alone ad-hoc networks, and the like, to provide an infrastructure-oriented connection for client devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 105 is configured to couple computing devices to each other, including, client device 101, content services 108-109, advertisement service 106, publisher service 107, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between RTS 106, and other computing devices.

Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

Content services 108-109 include virtually any computing device that is configured and arranged to provide any of a variety of content and/or services over a network. As such, content services 108-109 may operate as a website for enabling access to such content/services including, but not limited to blog information, educational information, music/video information, social networking content and/or services, messaging, or any of a variety of other content/services. However, content services 108-109 are not limited to web servers, and may also operate a messaging server, a File Transfer Protocol (FTP) server, a database server, or the like. Additionally, each of content services 108-109 may be configured to perform a different operation. Thus, for example, content provider 108 may be configured as a website server for multimedia content, while content service 109 is configured as a database server for a variety of content. Moreover, while content services 108-109 may operate as other than a website, they may still be enabled to receive an HTTP communication. In one embodiment, each content service 108-109 represents a content site that may receive content from one or more content providers for viewing by other than merely the content providers themselves. In one embodiment, a content provider might arrange web pages on one or more of content services 108-109 with content, to be viewed by a plurality of others. For example, a content provider, operating as a blogger, might post blog content on various web pages for viewing by others. The content provider might select to provide updates and/or new or revised content based on some pattern or frequency. For example, the content provider might select to provide content changes hourly, daily, weekly, or the like. In one embodiment, the content provider might have a discernable schedule in which content is posted. In another embodiment, however, the content provider might not have a discernable schedule, and might select to provide content, seemingly at random.

Moreover, the content provider might employ one of client devices 101-104 to provide the content. In one embodiment, the content provider might provide content that includes images, such as photographs, or the like, for posting. As such, the content provider might employ a variety of products and/or services to enable the content provider to post the content. Such products and/or services might include for example, but not be limited to software applications, scripts, applets, scanners, cameras, audio recorders, or the like. The content provider might also employ various services, such as might be provided by publisher service 107 to enable the posting of the content. For example, in one embodiment, publisher service 107 might provide storage capabilities, publishing tools, account management, or the like.

Thus, publisher service 107 includes virtually any computing device that is configured and arranged to provide network publication support products and/or services. In one embodiment, publisher service 107 may further be configured and arranged to coordinate requests for advertisement placements on a content site's web page, or the like. A content provider might select to request such advertisement placement through publication service 107, in one embodiment, by registering for the service through publisher service 107. In one embodiment, part of the registration might include providing to publisher service 107 information about the content provider, subject matter within which the advertisement might be place, an agreement regarding a number and/or type of advertisements to be posted, a frequency of advertisements to be posted, a fee or other form of compensation to be provided to the content provider for posting of the advertisement/messages, and the like.

In one embodiment, publisher service 107 may provide access to a snippet of code, link, applet, script, or the like, that is useable by the content provider to locate placement of advertisements and/or messages within web pages provided by the content provider on one or more of content services 108-109.

In one embodiment, publisher service 107 may be further configured and arranged to receive an indication that a request for access to a web page hosted on one of content services 108-109 is received for which an advertisement and/or message is to be displayed. Publisher service 107 may then determine which advertisement and/or message is to be displayed with the requested web page based on an analysis of content posted by the content provider, and based on identifying at least one content posting characteristic based on the content analysis.

Advertisement service 106 includes virtually any computing device that is configured and arranged to provide advertisements and/or messages for display within at least one web page hosted by content services 108-109. Advertisement service 106 may include a plurality of advertisements and/or messages stored within a data store that may be requested by publisher service 107. In another embodiment, the request for the advertisement/message may be received by other than publisher service 107. For example, in another embodiment, the snippet of code, link, or the like, embedded within the requested web page may also be configured to perform an analysis of content, identify content posting characteristics, select, and/or request an advertisement to be displayed on the web page, without departing from the scope of the invention.

Devices that may operate as advertisement service 106, content services 108-109, and/or publisher service 107 include, but are not limited to personal computers, desktop computers, multiprocessor systems, microprocessor-based or programmable consumer electronics, network PCs, servers, and the like. Although FIG. 1 illustrates advertisement service 106 and publisher service 107 as separate computing devices, the invention is not so limited. For example, advertisement service 106 and publisher service 107 may be implemented within a single network device, without departing from the scope of the invention. Moreover, publisher service 107 may be implemented within content services 108-109, without departing from the scope of the invention. Thus, the configuration of network devices illustrated in FIG. 1 should not be construed as narrowing the implementation of the invention, and other configurations are readily envisaged and therefore are within the scope of the invention.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252 that may be configured to receive an audio input as well as to provide an audio output, a display 254, a keypad 256, an illuminator 258, an input/output interface 260, a haptic interface 262, and a global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery. Client device 200 may also include a graphical interface 266 that may be configured to receive a graphical input, such as through a camera, scanner, or the like. In addition, client device 200 may also include its own camera 272, for use in capturing graphical images. In one embodiment, such captured images may be evaluated using OCR 268, or the like.

Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications and/or other data. For example, data storage 244 may also be employed to store information that describes various capabilities of client device 200, a device identifier, and the like. The information may then be provided to another device based on any of a variety of events, including being sent as part of a header during a communication, sent upon request, or the like.

In one embodiment, data storage 244 may also include cookies, address books, photographs, documents, and the like. At least a portion of the capability information, audio files, and the like, may also be stored on an optional hard disk drive 272, optional portable storage medium 270, or other storage medium (not shown) within client device 200.

Applications 242 may include computer executable instructions which, when executed by client device 200, transmit, receive, and/or otherwise process messages (e.g., SMS, MMS, IMS, IM, email, and/or other messages), audio, video, and enable telecommunication with another user of another client device. Other examples of application programs include calendars, browsers, email clients, IM applications, VOIP applications, contact managers, task managers, database programs, word processing programs, security applications, spreadsheet programs, games, search programs, and so forth. Applications 242 may further include browser 245, messenger 243, and Content Management Tools (CMT) 248.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed.

CMT 248 represents any of a variety of products and/or services useable to generate, edit, and/or post content to a content site. Thus, CMT 248 may include, but is not limited to web page publishing tools, editors, image editors, computer program development tools, video management tools, scanning tools, audio management tools, configuration management tools, and the like. For example, a content provider might employ a digital camera, a camera/phone, or the like, to take a photograph. The photograph may then be provided to client device 200 via a network, a USB connection, or by using any of a variety of other mechanisms. CMT 248 may then be used to edit the photograph, and/or otherwise prepare the photograph for posting at a content site, such as hosted by content services 108-109 of FIG. 1, or the like.

While CMT 248 is illustrated as residing within client device 200, the invention is not so limited. For example, some content management tools may also reside within another computing device, such as content services 108-109 of FIG. 1. For example, browser 245 might be configured to access one or more content management tools remotely.

### Illustrative Network Device

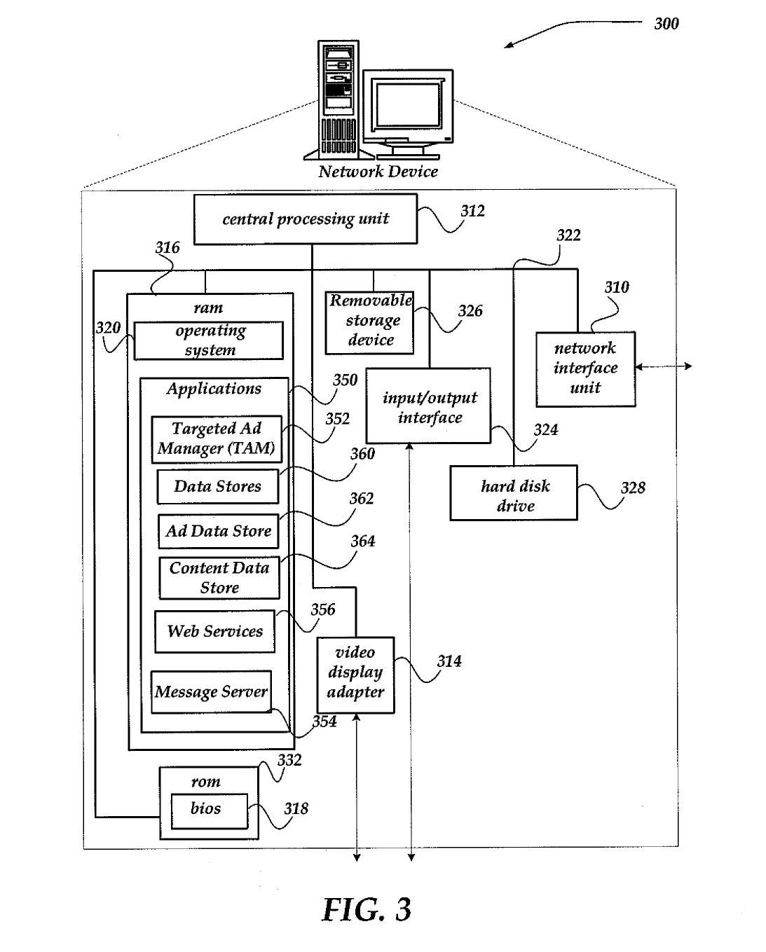

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, content services 108-109, and/or publisher service 107 of FIG. 1. In one embodiment, network device 300 is illustrated as a device configured to manage an integration of advertisement services, and content services in a single network device. However, as noted above, this configuration is not to be viewed as narrowing the scope of the invention, and such components may also be distributed across a plurality of different network devices, without departing from the scope of the invention.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, and removable storage device 326 that may represent a tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol, Wi-Fi, Zigbee, WCDMA, HSDPA, Bluetooth, WEDGE, EDGE, UMTS, or the like. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Applications 350 may also include Targeted Ad Manager (TAM) 352, message server 354, web services 356, data stores 360, Ad data store 362, and content data store 364.

Web services 356 represent any of a variety of services that are configured to provide content over a network to another computing device. Thus, web services 356 include for example, a web server, messaging server, a File Transfer Protocol (FTP) server, a database server, a content server, or the like. Web services 356 may provide the content over the network using any of a variety of formats, including, but not limited to WAP, HDML, WML, SMGL, HTML, XML, cHTML, xHTML, or the like. In one embodiment, web services 356 may interact with TAM 352 when a client device requests content, when content is revised by a content provider, and/or when an advertisement/message is to be displayed.

Message server 354 may include virtually any computing component or components configured and arranged to forward messages from message user agents, and/or other message servers, or to deliver messages to a local message store, such as data store 354, or the like. Thus, message server 354 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like.

However, message server 354 is not constrained to email messages, and other messaging protocols may also be managed by one or more components of message server 354. Thus, message server 354 may also be configured to manage SMS messages, IM, MMS, IRC, mIRC, or any of a variety of other message types.

TAM 352 is configured and arranged to manage selection of an advertisement/message for display within a web page, or the like, based on a type or category of a requester, and content posting characteristics. TAM 352 may monitor activities associated with changes to content, including, but not limited to a frequency of changes to content; determining a schedule for the changes in content; monitoring characteristics of the content, including, but not limited to a subject matter of the content, changes in a direction of the subject matter of the content, characteristics for images, videos, audio files, and the like, that may be available for posting; and the like. TAM 352 may then use such information, in part, to determine one or more content posting characteristics.

TAM 352 may also receive from web services 356 information indicating that a web page is being requested, and information useable to determine from whom the request is sent. For example, a GET command, or the like, might be monitored to indicate that a request for content is being received. TAM 352 may then receive a cookie, login information, or other identifiers that indicate whether the request is from the content provider, or from other than the content provider, such as from a viewer/reader of the content being posted. TAM 352 may then use the information about the requester, and content posting characteristics, to select an advertisement and/or message to be displayed with the requested content. In one embodiment, TAM 352 may employ a snippet of code, or the like, to enable the placement and/or receive the request for the advertisement/message in the content.

Moreover, TAM 352 may also receive recommendations from a content provider regarding advertisements/messages to be displayed when the requester of the content is other than the content provider. Such recommendations may be based on personal preferences input by the content provider. However, the recommendations may also be received based on the content provider having viewed an advertisement/message that was targeted for display to the content provider.

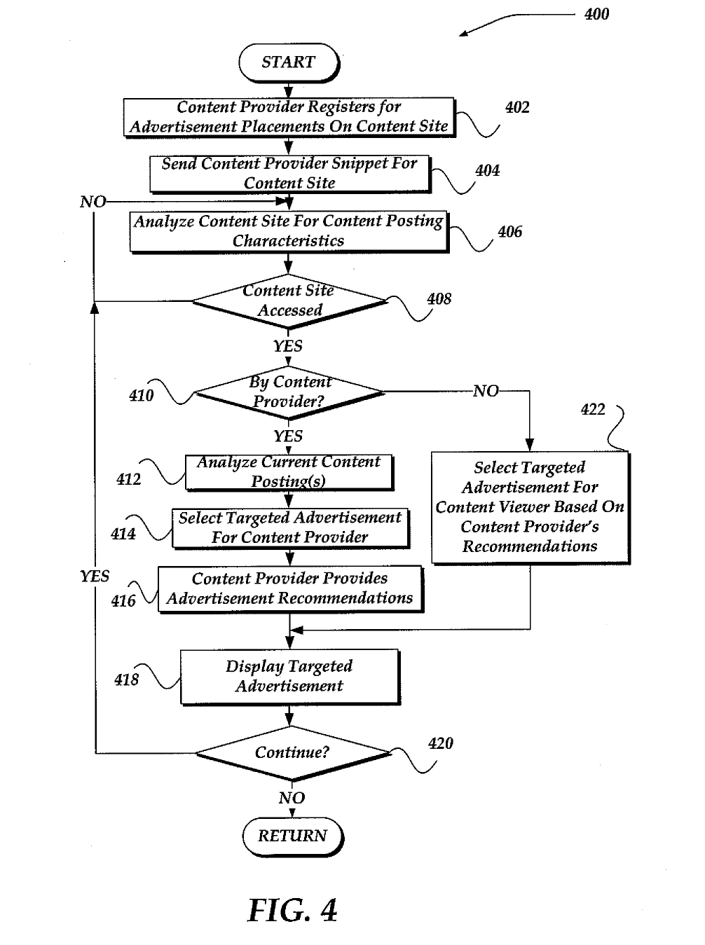

In one embodiment, TAM 352 may enable a content provider to register for display of advertisements/messages and to receive a snippet of code, applet, script, program, link, or the like, useable to enable the advertisement/message to be integrated within a web page. However, the invention is not so limited, and another component may also be configured to perform registration and/or provide the snippet. Thus, TAM 352 and/or another component may be configured to employ process 400 of FIG. 4 to perform at least some of their actions.

Data stores 360 includes virtually any component that is configured and arranged to store data including, but not limited to user preference data, log-in data, content posting characteristics, code snippets, reward/compensation data, and the like. Ad data store 362 includes virtually any component that is configured and arranged to store advertisements and/or messages that may be useable as targeted advertisements/messages to a content provider or content viewer other than merely the content provider. Content data store 364 includes virtually any component that is configured and arranged to store and manage content useable for access over a network. As such, data stores 360, ad data store 362, and/or content data store 364 may be implemented using a data base, a file, directory, or the like.

### Generalized Operation

The operation of certain aspects of the invention will now be described with respect to FIG. 4. FIG. 4 illustrates a logical flow diagram generally showing one embodiment of a process for managing advertisement selections targeted to at least a provider of content to a content site. Process 400 of FIG. 4 may be implemented within content services 108-109 of FIG. 1. However, the invention is not so limited, and at least a portion of process 400 may be implemented within publisher service 107, advertisement service 106, and/or one or more client devices 101-104 of FIG. 1. In one embodiment, content posted by a content provider, and/or an advertisement or other message, may be displayed at one or more client devices 101-104 of FIG. 1. As noted above, selection of which advertisement is to be displayed is determined in part based on the category in which the viewer seeking access to content from content services 108-109 is within. Thus, if the viewer is the provider of the content, one type of advertisement is selected for display; while if the viewer is other than a provider of the content, then another type of advertisement or message is selected for display.

Thus, process 400 begins, after a start block, at block 402, where a content provider or provider, registers for advertisement placement on a content site. In one embodiment, the content provider may provide various information about themselves, including, but not limited to a name, information about the content being posted, such as whether the content is associated with a blog, an image web page, such as a Flickr web page, video content, music content, or the like. In one embodiment, the content provider may indicate a subject matter of the content, such as being educational, comical, political, religious, dating, business related, or the like. In one embodiment, during block 402, the content provider's client device might receive an Internet cookie, digital certificate, or other mechanism useable to identify the content provider from another viewer of the content site. In one embodiment, the content provider may provide a login/password useable to identify the content provider.

In one embodiment, the registration may enable the content provider to be compensated for advertisement placements on the content site based on any of a variety of mechanisms, including, but not limited to a number of click-throughs, a cost per thousand impressions (CPM), a number of purchases identifiable to a viewer of the advertisement on the content site, or the like.

Processing flows next to block 404, where the content provider may be provided a snippet of code, including, but not limited to as a script, applet, widget, program, link, or the like, useable to enable a display of a targeted advertisement within a web page on the content site. The content provider may then embed or otherwise associate one or more web pages on the content site with the provided snippet. For example, the content provider might edit a web page to include the snippet. When the web page is accessed over a network, the snippet may operate to access for display a targeted advertisement.

Processing flows next to block 406, where an analysis of the content on the content site may be analyzed to identify one or more posting characteristics. Posting characteristics refer to those characteristics that identify a potentially useable feature about the content provider; the content provider's behaviors; the content provider's tools, products, and/or services; or the like. Such posting characteristics may be used to selected advertisements and/or other messages that are targeted to the content provider. Non-exhaustive examples of posting characteristics include but are not limited to information about a frequency of postings by the content provider; a schedule of postings; a content of the postings; a subject matter for which at least a subset of the content is directed; a product/service used by the content provider to prepare and/or post the content; and the like. For example, in the content posted includes an image, such as a photograph, metadata associated with an image file format associated with the photograph might be analyzed. The image file format might employ the Exchangeable image file format (Exif), in one embodiment, where the metadata might be located within a JPEG, TIFF, RIFF file, or the like. However, the invention is not constrained to this format and/or file types, and any of a variety of other files and/or file types might be analyzed to determine a posting characteristic. For example, the Extensible Metadata Platform (XMP) format might be used. In any event, analysis of the image file format data of the photograph might indicate a type of camera used, as well as how the photograph was taken including but not limited to an orientation, aperture, shutter speed, focal length, metering mode, ISO speed of the like. Additional information that might be obtained may include geo-coding data such as a geographical location of where the photograph was taken, or the like. Such posting characteristics may then be useable, for example, to select an advertisement or message targeted to products and/or services related to use of the camera used, a location where the photograph was taken, or the like. The invention is not limited to these posting characteristics, and/or uses thereof, and other posting characteristics, and/or uses thereof are also envisaged. Thus, the invention is not to be narrowed by such non-exhaustive examples.

Processing continues next to decision block 408, where a determination is made whether the content site is detected to be accessed. Such access may be determined using a variety of mechanisms, including, but not limited, for example, by detecting a request for a web page hosted at the content site. If an access is detected, processing flows to decision block 410; otherwise, processing may loop back to block 406 to continue analyzing the content site.

At decision block 410, a determination is made whether the content site is being accessed by the content provider or a viewer other than the content provider. In one embodiment, the determination may be based on receiving a cookie from the requester over the network. The cookie may then be used to identify if the request is from the content provider. However, the invention is not limited to use of cookies, and other mechanisms may also be used, including, but not limited to requesting a login/password that is useable to identify the requester as the content provider, monitoring an action or behavior of the viewer—such as receiving a request to post content—indicating a content provider type of behavior; or the like. In any event, if it determined that the content provider is requesting access to the content, processing moves to block 412; otherwise, processing moves to block 422.

At block 412, if the content provider is posting or has recently posted additional content, this content is also analyzed for any additional information useable to identify posting characteristics. Processing continues next to block 414, where an advertisement or other message may then be selected targeted to the content provider based on the information obtained from the posting characteristics. In one embodiment, the target advertisement and/or message may be targeted to products and/or services that the content provider might want to ‘sneeze’ to viewers of the content provider's viewers. For example, the advertisement might include products/services related to the subject matter of the content site. As a non-exhaustive, non-limiting example, the content site might be about boating. A targeted advertisement might then suggest that the content provider may want to sale advertisement space to a merchant to place advertisements about boating on the content provider's site. In this manner, the content provider might be a sneezer of information by providing the information to others through their postings, and selection of advertisements and/or messages to be posted. Thus, at block 416, the content provider may provide recommendations about advertisements and/or other messages that may be selected for targeting viewers of the content site, other than the content provider. Processing flows next to block 418.

At block 422, if the requester is other than the content provider, then an advertisement and/or other message is selected based on recommendations by the content provider. Processing continues next to block 418.

At block 418, one or more of the selected and targeted advertisements and/or messages are displayed to the requester for viewing within a web page, or other content viewing display. In one embodiment, the targeted advertisements/messages may change over time while the web page, or the like, is being displayed to the requester.

Processing flows next to decision 420, where a determination is made to continue processing the content site for targeted advertisements/messages. If so, processing loops back to block 406; otherwise, processing returns to a calling block to perform other actions. The determination may be based on any of a variety of criteria, including, for example, having received information from the content provider to cancel the postings, a removal of the snippet from the content site, or the like.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A computer-readable storage medium that includes data and instructions, wherein the execution of the instructions on a computing device provides for managing display of content over a network by enabling actions, comprising:
analyzing content posted on a network device by a content provider for access by at least one viewer other than the content provider;
identifying at least one content posting characteristic based on the content analysis;
selecting an advertisement displayable on the network device with at least a portion of the posted content based on the at least one content posting characteristic such that the selected advertisement is targeted to the content provider; and
if the network device is accessed by the content provider, displaying the selected advertisement to the content provider.

2. The computer-readable storage medium of claim 1, wherein the execution of the instructions enable actions, further comprising:
receiving a recommendation from the content provider based on the displayed advertisement;
selecting another advertisement based in part on the received recommendations such that the other advertisement is targeted to at least one viewer other than the content provider; and
if the network device is accessed by other than the content provider, displaying the selected other advertisement.

3. The computer-readable storage medium of claim 1, wherein at least one content posting characteristic further comprises at least one of a frequency of posting.

4. The computer-readable storage medium of claim 1, wherein analyzing the content posted further comprises:
if a portion of the posted content includes a photograph, examining image file format data associated with the photograph to identify at least one content posting characteristic.

5. The computer-readable storage medium of claim 1, wherein displaying the targeted advertisement includes displaying a name of the content provider with the advertisement.

6. The computer-readable storage medium of claim 1, wherein the targeted advertisement is directed to a product or service the content provider selects to have advertised to at least one viewer of the posted content other than the content provider.

7. A method for managing a communications over a network, comprising:
detecting a request to access at least one web page available from a network device;
determining if the request is by a content provider to at least web page for the network device;
analyzing content posted within at least one web page for the network device to determine at least one content posting characteristic; and
if the request to access is by the content provider for the at least one web page, displaying a message that is targeted to the content provider based on the at least one content posting characteristic.

8. The method of claim 7, wherein the at least one content posting characteristic further comprises at least one of a subject of the content, a frequency of the posting, or a product used to post the content by the content provider.

9. The method of claim 7, wherein the targeted message is an advertisement targeted to the content provider about at least one product or service useable to post content to the network device.

10. The method of claim 7, wherein analyzing the content further comprises analyzing at least one data file format associated with a image posted to within the at least one web page.

11. The method of claim 10, wherein displaying the message further comprises displaying a message that includes an advertisement for at least one product or service enabled to assist the content provider with obtaining another image for use in posting to the at least one web page.

12. A network device to manage a display of information over a network, comprising:
a transceiver to send and receive data over a network; and
a processor that is operative to perform actions, comprising:
receiving content from a content provider, the content to be posted on the network device;
analyzing the content to identify at least one content posting characteristic;
selecting an advertisement displayable on the network device with at least a portion of the posted content based on the at least one content posting characteristic such that the selected advertisement is targeted to the content provider; and
if the network device is accessed by the content provider, displaying the selected advertisement to the content provider.

13. The network device of claim 12, wherein at least one content posting characteristic comprises a frequency in which content is posted to the network device.

14. The network device of claim 12, wherein the advertisement is selected based on the content posted by the content provider.

15. The network device of claim 12, wherein the advertisement includes a message for a product or service to enable the content provider to post additional content to the network device.

16. The network device of claim 12, wherein the advertisement is about a product or service that the content provider might advertise to a viewer of the content posted by the content provider.

17. A client device for enabling a communications over a network, comprising:
a memory arranged to store data and instructions;
an input interface for receiving requests and sending responses; and
a processor arranged to enable actions embodied by at least a portion of the stored instructions, the actions comprising:
accessing a network device having content provided by a content provider;
receiving access to a web page having the content displayed thereon; and
displaying an advertisement within the web page, wherein the advertisement is selected based on a result of an analysis in part of the content to determine at least one content posting characteristic, and wherein:
if the content provider is associated with the mobile device, the advertisement is further selected to be targeted to the content provider, and
if a viewer other than the content provider is associated with the mobile device, the advertisement is further selected based on input from the content provider to be targeted to a viewer other than the content provider.

18. The client device of claim 17, wherein the advertisement is further selected to be targeted to the viewer further comprises selecting the advertisement based in part on a recommendation of an advertisement received from the content provider, wherein the content provider provides the recommendation based on an advertisement displayed within the web page to the content provider.

19. The client device of claim 17, wherein the at least one content posting characteristic further comprises information associated with a subject matter of the content posted by the content provider on the web page.

20. The client device of claim 17, wherein the at least one content posting characteristic further comprises a characteristic of a image capture device used to capture an image displayed by the content provider on the web page.
